(19) United States
(12) Patent Application Publication
(10) Pub. No.: US 2026/0134364 A1
(43) Pub. Date: May 14, 2026

(54) METHOD FOR ESTIMATING THE EFFORT REQUIRED FOR A PLANNED MILLING TASK PERFORMED OR TO BE PERFORMED USING A ROAD-MILLING MACHINE

(71) Applicant: Wirtgen GmbH, Windhagen (DE)

(72) Inventor: Markus Bach, Bonn (DE)

(21) Appl. No.: 19/444,584

(22) Filed: Jan. 9, 2026

Related U.S. Application Data
(63) Continuation of application No. 18/061,055, filed on Dec. 2, 2022.

(30) Foreign Application Priority Data
Dec. 15, 2021 (DE) 10 2021 133 306.7

(51) Int. Cl. G06Q 10/0631

(52) U.S. Cl. CPC G06Q 10/06312

(57) ABSTRACT

The method includes creating a self-learning system wherein, for each of numerous milling tasks, respective correction factors are determined for milling task specifications, and actual work effort is compared to estimated work effort which is based on sensed and recorded values for milling machine operating parameters and material parameters, the milling task specifications, and the corresponding correction factors. The correction factors are adjusted over time to account for determined deviations between actual and estimated work effort for a given combination of milling task specifications, machine operating parameters, and material parameters. During execution of a current milling task, respective correction factors are determined for milling task specifications, by reference to the self-learning system, and a work effort is estimated for the current milling task based on at least the correction factors. Operation settings are further adjusted and used for milling machine control based on the estimated work effort.

### CROSS-REFERENCES TO RELATED APPLICATIONS

This application is a continuation of U.S. patent application Ser. No. 18/061,055, filed Dec. 2, 2022, and further claims the benefit of German Patent Application No. DE 10 2021 133 306.7, filed Dec. 15, 2021, each of which are hereby incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD OF THE INVENTION

The invention relates to a method for estimating the effort of a planned milling task performed or to be performed using a road-milling machine, wherein task data is input into a machining device of a planning system, wherein the task data preferably comprise at least one preset machine parameter, preferably at least one material parameter, and at least one job parameter, wherein the preset machine parameter(s) contain(s) at least one specification of the set-up of the road-milling machine, wherein the material parameter(s) comprise(s) at least one specification characterizing the material of the ground surface to be machined, wherein the job parameter(s) comprise(s) at least one specification of the planned milling work or the planned milling performance.

### BACKGROUND

German Patent Application No. DE 10 20 15 111 249 A1 discloses a road-milling machine, in which preset machine parameters, material properties of the substrate to be milled and job parameters can be entered. Using characteristic diagrams, suitable target machine parameters can be computed from these preset values. The target machine parameters can be displayed to the machine operator. The machine operator can then decide whether to set these target machine parameters for the road-milling machine. Alternatively, the target machine parameters can be automatically transferred to a control unit for controlling the road-milling machine. It has been shown that such a method can be used to optimize the operation of a road-milling machine and make it user-friendly.

### BRIEF SUMMARY

The invention addresses the problem of providing a method, which can be used to determine the required machining effort for a planned milling job in a simple manner in advance.

This problem is solved in that the processing device determines the estimation of the effort from the task data, taking into account a construction site factor and/or a logistics factor.

According to the invention, “boundary conditions” resulting from the construction site itself or its surroundings are taken into account for estimating the effort. These “boundary conditions” are taken into account either as construction site factor(s) specifically affecting the construction site or as logistics factor(s).

The construction site factor(s) result from influences that make the upcoming milling task on the construction site easier or more complicated. In other words, the construction site factor takes into account the complexity of a construction site.

The logistics factor (or factors) take(s) into account effects resulting from the accompanying processes influencing the milling task at hand. In other words, the logistics factor can take the parameters that are influenced by the organization of the construction site into account.

The invention takes advantage of the knowledge that the complexity of the construction site and the organization of the construction site have an impact on the efficiency or milling performance of the road-milling machine. The complexity or organization of the construction site affects, for instance, the area or volume to be milled per unit of time, per quantity of fuel and/or per quantity of operating media required, and thus ultimately the duration of the construction site.

By taking construction site and logistics factors into account, a construction site planner is provided with an improved specification of the effort to be expected for a construction site. As the effort to be expected for a construction site, for instance, the required time, required operating materials, required operating media, expected wear and/or required wear/spare parts (in particular picks) can be indicated to the user. Construction site factors and logistics factors (time required, operating materials, operating media, wear and spare parts) influence these specifications per unit area and are taken into account according to the invention for a better estimation of the effort.

So basically, it is possible to compute the effort of a construction site first only depending on job parameters, as well as preferably at least one machine parameter and/or preferably one material parameter and then to correct this computed effort based on the construction site factor and/or the logistics factor to obtain the estimation of the effort. Alternatively, construction site factor and/or logistics factor can be taken into account directly when computing the effort.

Furthermore, it can alter controllable construction site factors or logistics factors to influence and alter the determined effort as desired. For instance, he may change one or more logistics factors to complete a construction site faster than is possible based on a preset setting. In this way, task planning becomes more precise and a road-milling machine can be better utilized. If the road-milling machine is part of a machine park comprising several road-milling machines, the overall utilization of the machine park can be improved.

The method according to the invention for estimating the effort of a planned milling task is performed by a processing device in the context of this invention. This processing device can have one or more input units, into which preferably the at least one preset machine parameter, the at least one material parameter and/or the at least one job parameter can be entered. A computing unit of the processing device is used to combine these input task data in an overall computation. In this regard, the processing device determines one or more output values that represent the estimation of the effort in the context of this invention. These output values can be displayed to a user at an output unit and/or these output values can be at least partially loaded into the control unit of the road-milling machine, for instance, to adjust the settings on the road-milling machine resulting from the output values. The output values can be displayed on the construction machine itself, but particularly advantageously the output values can be used for construction site and machine planning, for instance, by a construction site planner in a consultancy firm or by a milling service provider to prepare milling work.

Basically, the processing equipment to perform the estimation of the effort can be provided in the consultancy firm or at the milling service provider's.

Particularly advantageously, the processing device can be designed as a central computing unit in the form of a server, for instance, and provide access for a large number of participants to perform the estimation of the effort for construction projects to be performed.

According to a preferred embodiment of the invention, provision may be made for the estimation of the effort to include a specification of the duration of the planned milling task. In other words, the construction site planner receives an indication of how long a planned milling task will take or by what time a milling task can realistically be completed. This enables him to reliably plan the use of a road-milling machine or several road-milling machines on different construction sites.

In the context of this invention, preset machine parameters can be machine parameters that are to be set permanently or variably during the operation of the road-milling machine. As a non-exhaustive enumeration, one or more preset machine parameters may be selected from the list below:
planned milling depth;
stock of at least one operating material available on/at the road-milling machine. This takes into account the operating material(s) currently available at the road-milling machine, for instance, the amount of fuel available, etc.
stock of at least one operating medium available on/at the road-milling machine. This takes into account the operating media currently available on the road-milling machine, for instance, engine oil, engine coolant, and the amount of cooling water available to cool the milling drum during operation;
the state of wear of the tools currently present on the road-milling machine, which are directly or indirectly involved in the milling process. Tools directly involved in the milling process are, for instance, soil cultivation tools. Accordingly, the wear condition of the road milling picks, pick holders or pick ejectors installed on the milling drum can be taken into account. Tools indirectly involved in the milling process are, for instance, wear tools that are not directly exposed to the wear attack of the milled material removed.
planned feed rate of the road-milling machine. Here, a uniform feed rate or a varying feed rate during the work operation can be taken into account.
planned speed of the milling drum of the road-milling machine. To this end, a uniform feed rate or a varying feed rate during the work operation can be taken into account.
planned drive torque to be transmitted to the milling drum. To this end, a uniform drive torque or varying drive torques during operation can be taken into account.
working width of the milling drum of the road-milling machine.
milling drum type of the road-milling machine,
performance characteristics of the road-milling machine, e.g., performance characteristics of a drive motor driving the milling drum, and/or
drive torque transmitted to the milling drum.

In the context of the invention, material parameters may be one or more material parameters selected from the (non-exhaustive) list below:
material type of at least one area of the ground surface to be machined,
layer structure,
layer to be milled (surface course/binder course/base course/several layers),
hardness of at least one area of the ground surface to be machined, and/or
abrasiveness of at least one area of the ground surface to be machined.

In the context of the invention, job parameters can be parameters that result directly from the planned work task. In particular, these can be parameters resulting from the area to be milled and/or the volume of material to be milled during the planned operation of the milling drum. As a nonexhaustive enumeration, job parameters in terms of the invention may be one or more of the parameters selected from the (non-exhaustive) list below:
planned change to the ground surface to be machined,
planned milled length,
planned milling surface,
planned milling mass,
planned milling volume,
planned milling time, and/or
planned work result.

In the context of the invention, provision may be made for the construction site factor to represent or include a construction site correction specification that takes into account the complexity of the construction site where the planned milling task will be performed.

It may happen that the construction site correction specification results from factors that render the planned milling task on a construction site easier or more complicated.

In particular, it may happen that the construction site correction specification takes into account the geometry of the surface to be milled as at least one factor.

For instance, a simple geometric surface, such as a straight section of a highway, is easier and faster to mill than a geometrically complex shaped milling surface. For instance, a complicated milling surface in a city with multiple intersections will require a significantly higher milling effort. This geometric complexity of the construction site can be taken into account in the construction site correction specifications and thus in the construction site factor.

Furthermore, the construction site correction specifications may also take into account obstacles on or in the immediate vicinity of the construction site as at least one factor. In particular, bridges, traffic signs, manhole covers to be milled around and the like can be taken into account.

An obstacle in the area adjacent to the construction site can be, for instance, a lateral boundary of the milled area, such as a sidewalk, a house wall or the like, which make the processing of the milling surface more complicated and thus more costly. Such obstacles can therefore also be taken into account in the construction site correction specifications and therefore in the construction site factor.

When assessing the complexity of a construction site, changes to the milling profile of the milling surface to be created can also be considered as a factor. For instance, it is sometimes required that the milling depth should vary during a milling task. It is also conceivable that the width of the area to be milled varies.

If a section of a milling surface can be machined in one pass using a milling drum, this is much easier than if the milling surface has a great width, where several passes are required to remove the surface to be milled.

Furthermore, if several passes are necessary to machine a surface to be milled, the construction site correction factor can take maneuvering runs into account. In the context of the invention, a maneuvering run can be considered to be a motion of the road-milling machine during the machining operation in which no milling operation takes place. For instance, the length of the maneuvering run and/or the number of maneuvering runs can be taken into account.

It is also conceivable that the road-milling machine may need to be retooled or have its settings changed or adjusted during the machining operation. Such changes to the machine settings result in machine downtimes during which no milling operation is performed, or in phases during which the milling operation is limited. In this respect, the frequency and/or duration of changes to such machine settings can also be taken into account in the construction site correction factor as a further factor according to a variant of the invention.

Furthermore, it is conceivable that the error tolerance is taken into account when the work is performed. If, during a milling task, area limits of the surface to be milled are to be machined at high accuracy, then a change in the machining speed may be necessary, depending on the qualifications of the machine operator. Accordingly, if the margin of error is small, the complexity of the site may be greater. This can be taken into account in the construction site factor.

According to the invention, provision may therefore be made for the construction site factor to take into account at least one construction site specifications selected from the list below (not exhaustive):
geometry of the surface to be milled,
type and/or number of obstructions present on or adjacent to the area to be milled,
type and/or number of changes to the milling profile,
number of maneuvering runs required,
length of one or more maneuvering runs,
frequency of change of at least one machine parameter, and/or
tolerance for errors in the execution of work.

According to the invention, provision may be made for the logistics factor to take into account at least one logistics specifications selected from the list below (not exhaustive):
specification of the transport of the milled material,
specification of the loading of the milled material, and/or
specification of the supply of consumables, in particular operating materials and media, as well as spare and wear parts required by the road-milling machine at the construction site.

One or more of the specifications below may be considered when specifying the transport of the milled material (non-exhaustive list):
specification of the loading volume of the trucks used to transport the removal volume,
specification of the number of trucks available. If a sufficient number of trucks is available for the road-milling machine to be able work without interruption, this results in an effective completion of the construction site. If, on the other hand, the number of trucks is small, downtimes of the road-milling machine can occur, resulting in correspondingly longer processing times.
specification of the turnaround time, in particular the transport time, of a truck. The required number of trucks can be inferred from the turnaround time and, if applicable, the required loading time (this is the duration during which the truck picks up the milled material from the road-milling machine. Accordingly, the planning system can then be used to determine the required number of trucks.
specification of the duration of a truck change at the road-milling machine. As described above, a planning system according to the invention can be used to determine the number of trucks. A standard truck change duration can also be taken into account. However, to improve the conclusion, it is also conceivable that an absolute or relative specification of the duration of a truck change is entered into the planning system. Accordingly, a deviation from the aforementioned standard can be taken into account. For instance, if the space for the truck change is easy to use or more complicated, a factor to that effect can be implemented.
specification of the transport distance of a truck.
specification of the traffic situation on the transport route of the trucks. The traffic situation can influence the duration of the truck change to a considerable extent, for instance also in connection with the transport route. For instance, it is also conceivable that several time windows are considered throughout the day, in which the traffic situation varies.
specification of the quality of the logistics service provider. Depending on the quality of the logistics service provider, for instance, the duration, in which a truck change is performed, can vary.

In the context of the invention, provision may be made for one or more of the aforementioned transport specifications to be stored in the database of the processing device. The transport specifications can be displayed to the user in a list, for instance. From this list, the user can then select the desired transport specifications and transfer them to the processing device, or enter them manually into the processing device via an input unit.

One or more of the below may be included in the milled material loading specifications:

Partial loading of the milled material.

Full loading of the milled material.

No loading of the milled material.

For this purpose, the loading method is taken into account. Accordingly, it is taken into account whether the material milled by the road-milling machine is completely loaded onto trucks, or whether it is not loaded or only partially loaded onto trucks. In partial loading, part of the milled material is loaded onto trucks. The remainder remains on site, for instance on the milled surface. If no loading is performed, the milled material remains completely on site.

In the context of the invention, provision may be made for one or more of the aforementioned specifications of loading the milling material to be stored in the database of the processing device. The loading specifications can be displayed to the user, for instance, in a list. From this list, the user can then select the desired loading specifications and transfer them to the processing device, or enter them manually into the processing device via an input unit.

In the context of this invention, the logistics factor may also take into account logistics specifications that takes the on-site supply of consumables to the road-milling machine into consideration. Consumables can be, for instance, fuel, water, and/or spare parts. The logistics specifications can therefore take into account, for instance, the quality of the supply of consumables to the road-milling machine. The quality of supply of consumables to the road-milling machine can take into account the time required to bring each consumable to the site. Furthermore, accessibility to the road-milling machine on site can also be considered to make the consumables available at the road-milling machine.

In a method according to the invention, provision may be made for the construction site factor and/or the logistics factor to be determined from a functional relationship in which one or more construction site specifications is/are taken into account.

Preferably, the construction site planner uses the input unit to enter the construction site specifications and/or logistics specifications into the processing device.

The functional relationship can be stored in the processing device. The construction site factor and/or the logistics factor can then be determined in the processing facility based on this functional relationship and the construction site specifications and/or the logistics specifications.

It is also conceivable that a construction site factor selection list and/or a logistics factor selection list is/are stored in the processing device, for instance in a database. This construction site factor selection list and/or logistics factor selection list can be displayed to the user. The user can then directly or indirectly determine the suitable construction site factor or logistics factor from this list and confirm it or enter it into the processing device. This facilitates the usability of the planning system.

Preferably, the construction site factor selection list and/or the logistics factor selection list is formed from a class division, in which construction site types are divided into complexity classes, and that at least one complexity factor is assigned to each of the complexity classes. This makes for a quick and easy estimation of the construction site factor/logistics factor. In this way, it is possible with little effort to take the complexity of a construction site into account in the estimation of the effort based on a construction site factor, without the need to know the general conditions of the construction site to a high degree of detail.

The problem of the invention is also solved using a method for generating a data set, wherein an estimation of the effort is performed for a planned milling task as disclosed herein, wherein the milling task is performed by means of the road-milling machine, wherein data selected from the list below (non-exhaustive) is collected during the performance of the milling task:
at least one set machine parameter,
at least one actual material parameter, and/or
at least one actual job parameter,
wherein the actual work effort is determined from at least part of this recorded data, and wherein the actual effort is compared to the estimation of the effort and one or more correction factors, in particular an actual construction site factor and/or an actual logistics factor, is/are determined from this comparison.

According to the invention, therefore, an estimation of the effort is made, as explained above. The planned milling task is then performed. During the execution of the milling task, data is collected, in particular at least one set machine parameter, at least one actual material parameter and at least one actual job parameter. A comparison to the estimation of the effort can then be used to determine the actual site and logistics factors for the construction site. If there is a difference in regard to the assumption, the task data taken in the estimation of the effort can be adjusted. This makes for continuous improvement of the data stock and thus of the estimation of the effort.

As mentioned above, the construction site factor and/or the logistics factor can be selected from a selection list, in which certain construction site types are divided into complexity classes and wherein complexity factors are assigned to these complexity classes.

For instance, a construction site factor selection list may have this appearance:

| | |
|---|---|
| country road without intersection | construction site factor 1.0 |
| highway | construction site factor 0.8 |
| parking lot | construction site factor 0.6 |
| inner city construction site | construction site factor 1.3 |
| elaborate inner city construction site | construction site factor 1.6 |

A logistics factor selection list can be designed in a similar manner.

For the estimation of the effort, the user selects the appropriate construction site type and, in that way, obtains the construction site factor/logistics factor.

After the construction site has been completed and the milling task has been performed, the values actually recorded during the milling task are used to determine whether there is a deviation from the construction site factor/logistics factor according to the construction site factor/logistics factor selection list.

Within the scope of the invention, a large number of recorded milling tasks can now be stored in a database and compared to the preset values from the construction site factor selection list and the logistics factor selection list in a computing unit. If a systematic deviation shows up, a correction can be applied to the construction site factor or to the logistics factor. In other words, this creates a self-learning system that provides the basis for the improved estimation of the effort according to the invention.

In order to make such a method according to the invention particularly effective, wherein the most accurate possible construction site and/or logistics factors for the estimation of the effort are determined in a relatively short time, according to a variant of the invention provision may be made for the machine parameters, job parameters, and/or material parameters determined on the machine during a milling job from a large number of road-milling machines to be stored in the database.

To determine the at least one job parameter, the milling depth, the milling duration (i.e. the duration during which the road-milling machine is actively milling), the standstill times (i.e. the duration during which the engine is running but the machine is at a standstill), the number and duration of the maneuvering runs (i.e. the trips without milling operation) and/or the position data (for instance via GPS) can be determined, preferably continuously or at time intervals, and preferably sent to the processing device/database.

To determine the at least one actual material parameter, provision may be made, for instance, for the material properties to be derived from the machine parameters of the road-milling machine. Preferably, this data is determined continuously or at time intervals and preferably sent to the processing facility/database.

To determine the at least one set machine parameter, during the milling operation provision may be made for the feed rate, the milling drum infeed (milling depth), the actual milling drum speed, the actual drive torque, the working width of the milling drum and/or the milling drum type to be recorded. Preferably, this data is determined continuously or at time intervals and preferably sent to the database.

### BRIEF DESCRIPTION OF THE SEVERAL VIEWS OF THE DRAWINGS

The invention is explained in greater detail below based on exemplary embodiments shown in the drawings. In the Figures:

FIG. 1 shows a schematic diagram and a side view of a road-milling machine,

FIG. 2 shows a schematic representation of an arrangement for the estimation of the effort according to the invention using a processing device,

FIG. 3 shows a block diagram illustrating a possible sequence of an estimation of the effort according to the invention, and

FIGS. 4A and 4B each show a further block diagram, to illustrate the invention.

### DETAILED DESCRIPTION

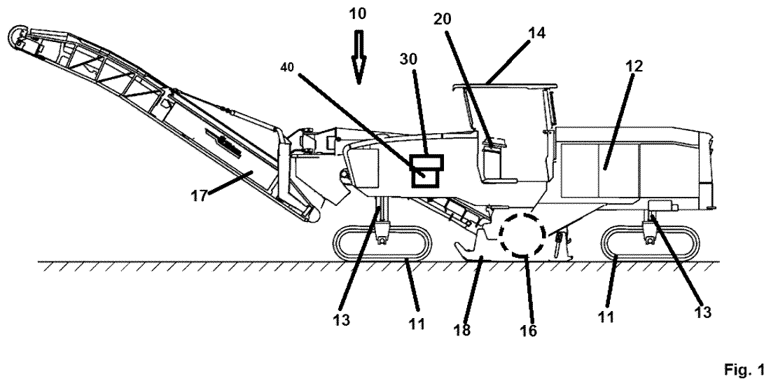

FIG. 1 shows a schematic diagram side view of an exemplary road-milling machine 10. A machine frame 12 is supported by an undercarriage 11, for instance crawler tracks, via four lifting columns 13 in a height-adjustable manner. The ground milling machine 10 can be operated, based on a control station 14, via a user interface 20 arranged in the control station 14. A milling drum 16, which is arranged in a concealed manner and is shown as a dashed line in the illustration, is rotatably mounted in a drum housing 18 between the front and rear undercarriage 11. A conveyor 17 is used to remove the milled material.

In use, the machine frame 12 is moved along the ground to be machined at a feed rate entered via the user interface 20 by means of the undercarriage 11. Milling tools, in particular picks, in particular round shank picks, arranged on the rotating milling drum 16 remove the substrate.

The user interface 20 can be used to adjust the vertical position and the speed of the milling drum 16. The milling depth is set via the vertical position of the milling drum 16. Depending on the machine type, the height-adjustable lifting columns 13 or other suitable means can be used to adjust the vertical position of the milling drum 16. Alternatively, the milling drum 16 can be adjusted in height relative to the machine frame 12, for instance.

The road-milling machine 10 has the control unit. Part of this control unit may be a processing device 40, or may comprise a processing device 40. The processing device 40 may alternatively also be provided as a separate unit preferably at the road-milling machine 10.

In the context of the invention, the processing device 40 may also comprise or form a further processing device.

Alternatively, the processing device 40 and/or the further processing device may be arranged separately from the road-milling machine 10. The processing device can be designed as a stand-alone computer which can be used to perform estimations of the effort for the execution of milling tasks in the preparation of construction sites.

In particular, the processing device 40 may be located, for instance, in a consultancy firm or at a milling service provider.

Particularly advantageously, the processing device 40 can be designed as a central computing unit in the form of a server, for instance, and provide access for a large number of participants to perform estimations of the effort for construction projects to be performed. Such a system is particularly advantageous when, after a milling task has been performed, the actual operating conditions and effort of the construction site are returned into the system, in that way creating a predictive system for estimation of the effort that is based on a large database.

In the context of the invention, the processing device 40 may also be wire-connected or radio linked to the control unit of the road-milling machine 10. The operator of the road-milling machine can then view the expected workload for an upcoming construction site.

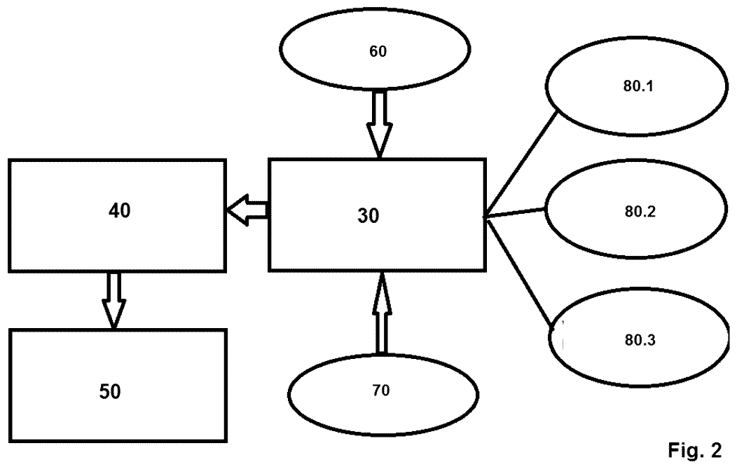

FIG. 2 shows the processing device 40 in a schematic manner. An input unit 30 is or can be assigned to this processing device 40. The input unit 30, which can also be designed as an acquisition unit, is used to acquire at least one job parameter 80.2, preferably at least one material parameter 80.1 and preferably at least one preset machine parameter 80.3. Additionally or alternatively, the input unit 30 can be used to manually input at least one job parameter 80.2, preferably at least one material parameter 80.1, and preferably at least one preset machine parameter 80.3.

The at least one job parameter 80.2, the preferably at least one material parameter 80.1 and/or the preferably at least one preset machine parameter 80.3 can also be taken from a planning system for estimating the effort required to plan a construction site. In such a system, for instance, the location, time and general conditions of a milling task to be performed can be stored and retrieved for an estimation of the effort by the input unit 30.

The values entered into the input unit 30 represent task data in terms of the invention. They are transmitted to the processing device 40.

As FIG. 2 further indicates, at least one construction site factor 60 and/or at least one logistics factor 70 can also be entered into the input unit 30. The at least one construction site factor 60 and/or the at least one logistics factor 70 is/are also transmitted to the processing device 40.

The processing device 40 determines an estimation of the effort from the task data, taking into account the construction site factor 60 and/or the logistics factor 70. This estimation of the effort includes a conclusion about how costly processing a planned construction site is. The estimation of the effort may be displayed on a display device 50 connected to the processing equipment 40. The display device 50 may also represent another entity used to visualize the effort of the upcoming construction site to a user. In particular, there may be more than one display device. For instance, when performing the centralized planning of a construction site as described above, the estimation of the effort may be displayed to the construction site planner immediately and to the operator of the road-milling machine 10 before or during the performance of the milling task.

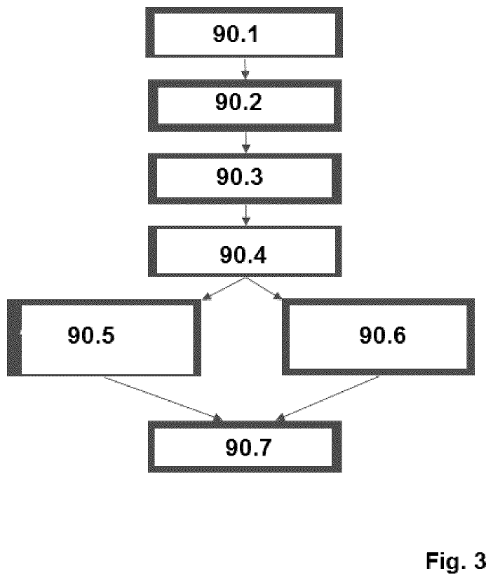

FIG. 3 shows a block diagram illustrating a possible sequence of an effort estimation method according to the invention. As this embodiment shows, a job parameter 80.2 can first be recorded or entered by a user via the input unit 30 (block 90.1). In addition, a machine parameter (block 90.2) and/or a material parameter 80.1 (block 90.3) can be recorded and/or entered via the input unit 30.

Machine and material parameters 80.1 in particular can change in the course of a construction site. If the processing device 40 is located on the road-milling machine 10 or if the road-milling machine 10 is connected to the processing device 40, then these changes can be detected while the milling task is being performed. If these are unexpected changes that were not considered in the original estimation of the effort, the estimation of the effort can be adjusted during the execution of the milling job. These changes can be shown to the machine operator and/or the site planner on the display unit 50.

This entered task data are transferred to the processing device 40. A preliminary estimation of the effort (block 90.4) is performed in the processing device 40, which may in particular be a computing unit, wherein the expected effort for processing a construction site using a road-milling machine 10 is computed from the input data. This preliminary estimation of the effort may be illustrated to the user on a display device 50, as noted above.

If the user agrees with the result, the process is completed.

However, if the user wishes to obtain a more accurate estimation of the effort, he has the option, according to the invention, of correcting the preliminary estimation of the effort by entering a construction site factor 60 (block 90.5) and/or a logistics factor 70 (block 90.6). The construction site factor and/or the logistics factor 70 is/are recorded in the processing device 40, for instance via the input unit 30. The preliminary estimation of the effort is then used to compute an estimation of the effort in accordance with the invention in the processing device 40 (block 90.6). it can be shown to the user in the display device 50.

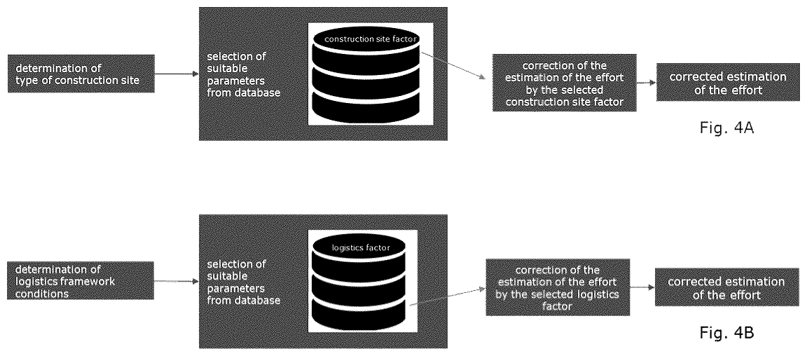

The block diagrams shown in FIG. 4a and FIG. 4b illustrate more clearly how the preliminary estimation of the effort can be corrected in concrete terms to obtain the estimation of the effort according to the invention.

FIG. 4a describes the correction of an estimation of the effort based on a construction site factor of 60.

FIG. 4b describes the correction of an estimation of the effort based on a logistics factor 70.

As FIG. 4A shows, a user determines the type of construction site planned.

According to FIG. 4B, the user determines the logistics framework conditions that will arise in connection with the processing of the construction site.

In the variant according to FIG. 4A, selection lists are displayed to the user on the above-mentioned display device 50 or on another display device. In particular, a construction site factor selection list that is stored in a database can be shown. In this database, complexity classes, to which at least one complexity factor is assigned, can be stored in the construction site factor selection list. The user then has the option of selecting the complexity class that applies to the planned construction site from the proposed complexity classes. Once selected, the processing device 40 is used to retrieve the complexity factor assigned for the selected complexity class from the database via. This complexity factor is then processed in the processing facility to correct the preliminary estimation of the effort. As a result, the user receives the corrected estimation of the effort.

In the variant according to FIG. 4B, selection lists are displayed to the user on the above-mentioned display device 50 or on another display device. In particular, a logistics factor selection list that is stored in a database can be shown. In this database, complexity classes to which at least one complexity factor is assigned can be stored in logistics site factor selection list. The user then has the option of selecting the complexity class that applies to the planned construction site from the proposed complexity classes. Once selected, the processing device 40 is used to retrieve the complexity factor assigned for the selected complexity class from the database. This complexity factor is then processed in the processing facility to correct the preliminary estimation of the effort. As a result, the user receives the corrected estimation of the effort.

In principle, the construction site factor 60 or the logistics factor 70 can be used to first correct the estimation of the effort and then, based on the result obtained in this way, a further correction can be performed using the other factor of the construction site factor 60 and the logistics factor 70 to obtain a final estimation of the effort.

What is claimed is:

1. A processor-implemented method for controlling performance of a milling task by a road-milling machine based on real-time estimation of an effort required, the method comprising:
creating a self-learning system wherein, for each of a plurality of milling tasks performed by each of a plurality of road-milling machines:
respective values are sensed during the milling task and stored in a database in association with each of at least one machine operating parameter and at least one material parameter characterizing a material of a ground surface to be machined;
a respective correction factor is determined for each of at least one milling task specification, and
an actual work effort for the milling task is compared to an estimated work effort, wherein the estimated work effort is based on at least the recorded values, the at least one milling task specification, and the corresponding at least one correction factor, and
wherein the at least one correction factor is adjusted over time and stored in the database to account for determined deviations between the actual work effort and the estimated work effort for a given combination of milling task specifications, machine operating parameters, and actual material parameters;
during execution of a current milling task:
determining and recording respective values in association with each of at least one machine operating parameter and at least one actual material parameter;
determining a respective correction factor for each of at least one milling task specification, by reference to the database with respect to the sensed values and the at least one milling task specification;
estimating a work effort for the current milling task based on at least the recorded values, the at least one milling task specification, and the corresponding at least one correction factor;
adjusting one or more operation settings on a control unit of the road-milling machine based on the estimated work effort; and
automatically controlling operation of the road-milling machine based at least in part on the adjusted one or more operation settings.

2. The method of claim 1, wherein the at least one milling task specification comprises a specification of a duration of the milling task.

3. The method of claim 1, wherein one or more of the at least one machine operating parameter are selected from one or more of: a milling depth; a stock of at least one operating material available at/on the road-milling machine; a stock of at least one operating medium available at/on the road-milling machine; a feed rate of the road-milling machine; a speed of a milling drum; a drive torque transmitted to the milling drum; a working width of the milling drum of the road-milling machine; a milling drum type; and a performance characteristic of the milling machine.

4. The method of claim 1, wherein one or more of the at least one actual material parameter are selected from one or more of: a material type of at least one area of the ground surface to be machined; a layer structure; a layer to be milled; a hardness of at least one area of the ground surface to be machined; and an abrasiveness of at least one area of the ground surface to be machined.

5. The method of claim 1, wherein one or more of the at least one milling task specification takes into account a complexity of a construction site where the milling task is performed.

6. The method of claim 1, wherein one or more of the at least one milling task specification takes into account an organization of a construction site where the milling task is performed.

7. The method of claim 1, wherein one or more of the at least one milling task specification is selected from one or more of: a geometry of a surface to be milled; a type and/or number of obstructions present on or adjacent to an area to be milled; a type and/or number of changes to a milling profile; a number of maneuvering runs required; a length of one or more maneuvering runs; a frequency of change of at least one machine parameter; and a tolerance for errors in execution of a milling task.

8. The method of claim 1, wherein one or more of the at least one milling task specification is selected from one or more of: specification of transport of milled material; specification of loading of the milled material; and specification of a supply of consumables required by the road-milling machine at a construction site.

9. The method of claim 8, wherein the specification of transport of the milled material takes into account one or more of: specification of a loading volume of trucks used to transport removal volume; specification of a number of trucks available; specification of a transport time of a truck; specification of a duration of a truck change at the milling machine; specification of a transport distance of the truck; specification of a traffic situation on a transport route of the trucks; and specification of a quality of a logistics service provider.

10. The method of claim 8, wherein the specification of loading of the milled material takes into account one or more of: partial loading of the milled material; full loading of the milled material; and no loading of the milled material.

11. The method of claim 1, wherein:
a first processing device separate from each of the road-milling machines is configured to at least create the self-learning system; and
each of the road-milling machines comprises a respective further processing device configured to adjust the one or more operation settings on a control unit of the road-milling machine based on the estimated work effort, wherein the control unit of the respective road-milling machine is configured to automatically control operation of the road-milling machine based at least in part on the adjusted one or more operation settings.
